(19) United States
(12) Patent Application Publication
(10) Pub. No.: US 2025/0384613 A1
(43) Pub. Date: Dec. 18, 2025

(54) Building Group Rendering in Virtual Environments

(71) Applicant: Tencent Technology (Shenzhen) Company Limited, Shenzhen (CN)

(72) Inventors: Heng Cai, Shenzhen (CN); Yingpeng Zhang, Shenzhen (CN)

(21) Appl. No.: 19/303,620

(22) Filed: Aug. 19, 2025

Related U.S. Application Data
(63) Continuation of application No. PCT/CN2024/105191, filed on Jul. 12, 2024.

(30) Foreign Application Priority Data
Sep. 8, 2023 (CN) 2023111535127

(51) Int. Cl. G06T 15/04

(52) U.S. Cl. CPC G06T 15/04; G06T 2210/04

(57) ABSTRACT

Aspects described herein include techniques for rendering a building group model by processing texture data. The technique includes obtaining the model, which specifies rendering material parameters including multiple building texture maps with associated map information. These maps are spliced to form a physical texture map. For each pixel in a target building block model, the system determines corresponding physical texture coordinates in the physical texture map and virtual texture coordinates in a preset virtual texture map. The technique identifies the virtual texture block containing those coordinates and maps it to the corresponding portion of the physical texture map. The virtual texture map is filled with that portion, and a texture pixel matching the virtual texture coordinates is sampled. The system then renders each target building block model using the matched texture pixels, enabling accurate and efficient texture mapping across multiple buildings within the group.

### CROSS REFERENCE TO RELATED APPLICATIONS

This application is a continuation application of PCT Application PCT/CN2024/105191, filed Jul. 12, 2024, which claims priority to Chinese Patent Application No. 2023111535127, filed with the China National Intellectual Property Administration on Sep. 8, 2023, each entitled “BUILDING GROUP RENDERING METHOD AND APPARATUS, COMPUTER DEVICE, AND STORAGE MEDIUM”, and each of which is incorporated herein by reference in its entirety.

### FIELD

This application relates to the field of computer technologies, and in particular, to a building group rendering method and apparatus, a computer device, a storage medium, and a computer program product.

### BACKGROUND

With the development of computer technologies, image rendering processing technologies also rapidly develop, and a computer device may perform image rendering by calling a drawing interface. In a process of calling the drawing interface, a central processing unit of the computer device calls an underlying graphic drawing interface, to instruct a graphic processing unit to perform a rendering operation.

In the conventional technology, in a scenario of rendering a building group, buildings in the building group are first modeled to obtain a plurality of building models, and then rendering is respectively performed by using materials of the plurality of building models. Each building model has a plurality of faces. To enable different faces of the building group to present different visual effects, different materials may be usually set for the different faces, and different maps are provided for the different materials, so that faces having different maps can present different visual effects.

However, in a conventional method, a plurality of materials are used during rendering of the building group. Because the computer device cannot merge models with different materials to call the drawing interface, for one rendered image, the drawing interface can only be called for a plurality of times during rendering. As a quantity of materials increases, a quantity of times of calling the drawing interface by the central processing unit also increases, which easily causes overload of the central processing unit. In addition, an increase in the quantity of material also means an increase in a quantity of maps, which occupies a large amount of video memory and affects normal running of the computer device.

### SUMMARY

This application provides a building group rendering method and apparatus, a computer device, a computer-readable storage medium, and a computer program product.

According to a first aspect, this application provides a building group rendering method, which is performed by a computer device. The method includes:
obtaining a building group model, the building group model indicating a rendering material parameter configured for rendering a building group, the rendering material parameter including texture data, the texture data including map information of a plurality of building texture maps of the building group model, and the building group model including at least one to-be-rendered target building block model;
splicing the plurality of building texture maps based on the map information in the texture data, to generate a physical texture map of the building group model;
determining, for each target pixel point configured for performing texture sampling in the at least one target building block model, physical texture coordinates corresponding to the target pixel point in the physical texture map, and determining virtual texture coordinates corresponding to the target pixel point in a preset virtual texture map based on the physical texture coordinates;
determining a virtual texture block in which the virtual texture coordinates are located in the virtual texture map, and determining a part of the physical texture map corresponding to the virtual texture block in the physical texture map based on a mapping relationship between the virtual texture map and the physical texture map;
filling the virtual texture map with a part of the physical texture map corresponding to the target pixel point, and sampling, from the virtual texture map, a texture pixel matching the virtual texture coordinates corresponding to the target pixel point; and
rendering the at least one target building block model by using the texture pixel matching the virtual texture coordinates corresponding to each target pixel point.

According to a second aspect, this application provides a building group rendering apparatus. The apparatus includes:
a model obtaining module, configured to obtain a building group model, the building group model indicating a rendering material parameter configured for rendering a building group, the rendering material parameter including texture data, the texture data including map information of a plurality of building texture maps of the building group model, and the building group model including at least one to-be-rendered target building block model;
a map generation module, configured to splice the plurality of building texture maps based on the map information in the texture data, to generate a physical texture map of the building group model;
a coordinate conversion module, configured to: determine, for each target pixel point configured for performing texture sampling in the at least one target building block model, physical texture coordinates corresponding to the target pixel point in the physical texture map, and determine virtual texture coordinates corresponding to the target pixel point in a preset virtual texture map based on the physical texture coordinates;
a texture sampling module, configured to determine a virtual texture block in which the virtual texture coordinates are located in the virtual texture map, determine a part of the physical texture map corresponding to the virtual texture block in the physical texture map based on a mapping relationship between the virtual texture map and the physical texture map, fill the virtual texture map with a part of the physical texture map corresponding to the target pixel point, and sample, from the virtual texture map, a texture pixel matching the virtual texture coordinates corresponding to the target pixel point; and
a rendering module, configured to render the at least one target building block model by using the texture pixel matching the virtual texture coordinates corresponding to each target pixel point.

According to a third aspect, this application further provides a computer device. The computer device includes a memory and a processor, the memory having a computer program stored therein, and the processor, when executing the computer program, implementing the foregoing building group rendering method.

According to a fourth aspect, this application further provides a computer-readable storage medium. The computer-readable storage medium has a computer program stored therein, and the computer program, when executed by a processor, implements the foregoing building group rendering method.

According to a fifth aspect, this application further provides a computer program product. The computer program product includes a computer program, and the computer program, when executed by a processor, implements the foregoing building group rendering method.

Details of one or more aspects described herein are provided in the accompanying drawings and descriptions below. Other features, objectives, and advantages described herein become obvious with reference to the specification, the accompanying drawings, and the claims.

### BRIEF DESCRIPTION OF THE DRAWINGS

To describe the technical solutions in the aspects described herein or the conventional technology more clearly, the following briefly describes the accompanying drawings required for describing the aspects or the conventional technology. The accompanying drawings in the following description show merely the aspects described herein, and a person of ordinary skill in the art may still derive other drawings from these accompanying drawings without creative efforts.

FIG. 1 is a diagram of an application environment of a building group rendering method according to an aspect.

FIG. 2 is a schematic flowchart of a building group rendering method according to an aspect.

FIG. 3 is a schematic diagram of a configuration interface for importing configuration according to an aspect.

FIG. 4 is a schematic diagram of a physical texture map according to an aspect.

FIG. 5 is a schematic diagram of a physical texture map according to another aspect.

FIG. 6 is a schematic diagram of a rendered image according to an aspect.

FIG. 7 is a schematic diagram of determining physical texture coordinates according to an aspect.

FIG. 8 is a schematic diagram of obtaining a part of a physical texture map corresponding to a target pixel point according to an aspect.

FIG. 9 is a schematic flowchart of a loading process according to an aspect.

FIG. 10 is a schematic flowchart of a rendering process according to an aspect.

FIG. 11 is an effect diagram of using a conventional solution according to an aspect.

FIG. 12 is an effect diagram of using a solution described herein according to an aspect;

FIG. 13 is an effect diagram of using a conventional solution according to another aspect.

FIG. 14 is an effect diagram of using a solution described herein according to another aspect.

FIG. 15 is a structural block diagram of a building group rendering apparatus according to an aspect.

FIG. 16 is a diagram of an internal structure of a computer device according to an aspect.

### DETAILED DESCRIPTION

The technical solutions in aspects described herein are described below with reference to accompanying drawings in the aspects described herein. The described aspects are merely some rather than all of the aspects described herein. Based on the aspects described herein, all other aspects obtained by a person of ordinary skill in the art without creative efforts shall fall within the protection scope described herein.

This application relates to a computer vision (CV) technology. The computer vision is a science that studies how to enable a machine to “see”, and furthermore, to implement machine vision such as recognition and measurement for a target by using a camera and a computer in replacement of human eyes, and further perform graphic processing, so that the computer processes the target into an image more suitable for human eyes to observe, or more suitable to be transmitted to an instrument for detection. As a scientific discipline, the computer vision studies related theories and technologies in an attempt to establish an artificial intelligence system that can obtain information from images or multidimensional data. The computer vision technology generally includes technologies such as image processing, image recognition, image semantic understanding, image retrieval, optical character recognition (OCR), video processing, video semantic understanding, video content/behavior recognition, three-dimensional object reconstruction, a three-dimensional technology, virtual reality, augmented reality, simultaneous localization, and map construction, and further include biometric feature recognition technologies such as common face recognition and fingerprint recognition. A building group rendering method described herein means performing rendering processing on a building group model based on the computer vision technology.

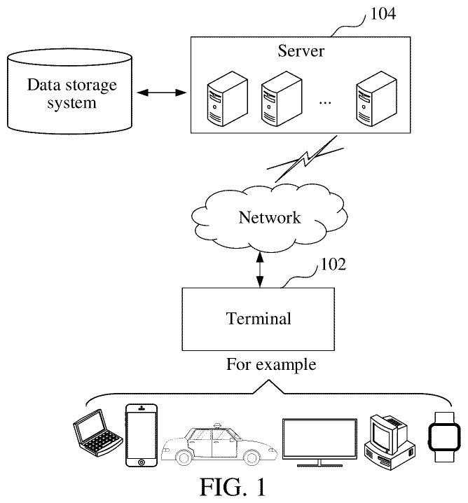

The building group rendering method provided in the aspects described herein may be applied to an application environment shown in FIG. 1. A terminal 102 communicates with a server 104 through a network. A data storage system may store data that the server 104 needs to process. The data storage system may be integrated on the server 104, or placed on a cloud or another server. The terminal 102 may obtain a building group model from the server 104, the building group model indicating a rendering material parameter configured for rendering a building group, the rendering material parameter including texture data, the texture data including map information of a plurality of building texture maps of the building group model, and the building group model including at least one to-be-rendered target building block model; splice the plurality of building texture maps based on the map information in the texture data, to generate a physical texture map of the building group model, the physical texture map being formed by splicing the plurality of building texture maps; determine, for each target pixel point configured for performing texture sampling in the at least one target building block model, physical texture coordinates corresponding to the target pixel point in the physical texture map; determine virtual texture coordinates corresponding to the target pixel point in a preset virtual texture map based on the physical texture coordinates; fill, based on the virtual texture coordinates, the virtual texture map with a part of the physical texture map corresponding to the target pixel point; sample, from the virtual texture map, a texture pixel matching the virtual texture coordinates corresponding to the target pixel point; and render the at least one target building block model by using the texture pixel matching the virtual texture coordinates corresponding to each target pixel point. The terminal 102 may be, but is not limited to, a desktop computer, a notebook computer, a smart phone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart band, a head-mounted device, or the like. The server 104 may be implemented by using an independent server or a server cluster that includes a plurality of servers.

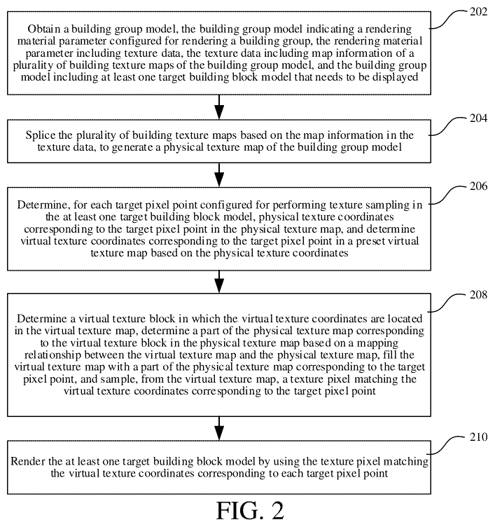

In an aspect, as shown in FIG. 2, a building group rendering method is provided. The method may be independently performed by a terminal or a server, or may be jointly performed by a terminal and a server. In this aspect described herein, an example in which the method is applied to the terminal is used for description. The method includes the following operations.

Operation 202: Obtain a building group model, the building group model indicating a rendering material parameter configured for rendering a building group, the rendering material parameter including texture data, the texture data including map information of a plurality of building texture maps of the building group model, and the building group model including at least one to-be-rendered target building block model.

The building group refers to a cluster including a plurality of buildings, and is a result that needs to be obtained through rendering. The building group model refers to a model established for the building group, and is configured for rendering the building group. For example, the building group model may specifically refer to a three-dimensional model established for the building group. The building group model includes a plurality of building block models obtained by splitting, and each building block model includes at least one building model. The building model may include a plurality of patch meshes, and a position at which two adjacent patch meshes intersect is a vertex of the building model. Each vertex of the building model has a corresponding vertex attribute, which is configured for describing the vertex. For example, the vertex attribute may specifically include corresponding map texture coordinates of the vertex in a corresponding building texture map, position information of the vertex in a world coordinate system, and the like. The rendering material parameter indicated by the building group model may be included in the building group model, or a position of the rendering material parameter may be recorded and stored by the building group model. The position is, for example, a folder path.

The rendering material parameter is a material configured for rendering the building group model. In this aspect, the rendering material parameter includes the texture data, and the texture data includes the map information of the plurality of building texture maps of the building group model. In some aspects, the texture data may be a texture array. The texture array may package a plurality of building texture maps into an array, and perform calling during rendering.

The building texture map is a flat image covering a surface of the building model, and stores a graphic feature of the surface of the building model. The building texture map may actually be a two-dimensional array, and elements in the two-dimensional array are some color values. When the building texture map is mapped to the surface of the building model in a specific manner, the building model can look more realistic, that is, the building texture map may be configured for reflecting content included in a building model that needs to be rendered. The building texture map of each building model may be pre-drawn based on an actual application scenario. The map information is information configured for obtaining the building texture map. For example, the map information may specifically refer to a reference path configured for obtaining the building texture map. A file handle of the building texture map may be obtained through the reference path, so that any operation may be performed on the building texture map through the file handle.

The at least one to-be-rendered target building block model refers to a target building block model that needs to be displayed on the terminal. The building group model is split, so that the building group model may be split into the plurality of building block models, and each time the building group model is displayed on the terminal, only a target building block model needs to be displayed in the plurality of building block models. Only the at least one target building block model is displayed, so that a deletion function of a rendering engine can be fully used, and rendering performance can be improved. The target building block model is at least some building block models needing to be rendered in a building group model determined based on a current observation perspective. A building block model other than the at least some building block models needing to be rendered does not affect a finally rendered building group.

Specifically, when performing building group rendering, the terminal obtains the building group model, the building group model indicating the rendering material parameter configured for rendering the building group, the rendering material parameter including the texture data, and the texture data including the map information of the plurality of building texture maps of the building group model. In a specific application, the building group model includes the plurality of building block models obtained by splitting, and the plurality of building block models may be obtained by splitting a plurality of building models included in an initial model of the building group.

In a specific application, the initial model of the building group and the plurality of building texture maps are drawn by a drawing object by using computer graphics software (such as Houdini). After the drawing is completed, an engine editor may obtain the initial model of the building group including the plurality of building models and the plurality of building texture maps that are outputted from the computer graphics software, and convert the initial model of the building group including the plurality of building models and the plurality of building texture maps into a format that can be used by the rendering engine, to generate the rendering material parameter. The terminal obtains the rendering material parameter generated by the engine editor. The format that can be used by the rendering engine herein may be configured according to the actual application scenario.

In a specific application, the engine editor may convert, through a pre-configured building group import tool, the initial model of the building group including the plurality of building models and the plurality of building texture maps into the format that can be used by the rendering engine, to generate the rendering material parameter. During importing, the engine editor first merges the plurality of building texture maps into the texture data, adds indexes of corresponding building texture maps in the texture data to vertexes of the plurality of building models, and then generates the rendering material parameter based on the texture data, to facilitate use by the rendering engine.

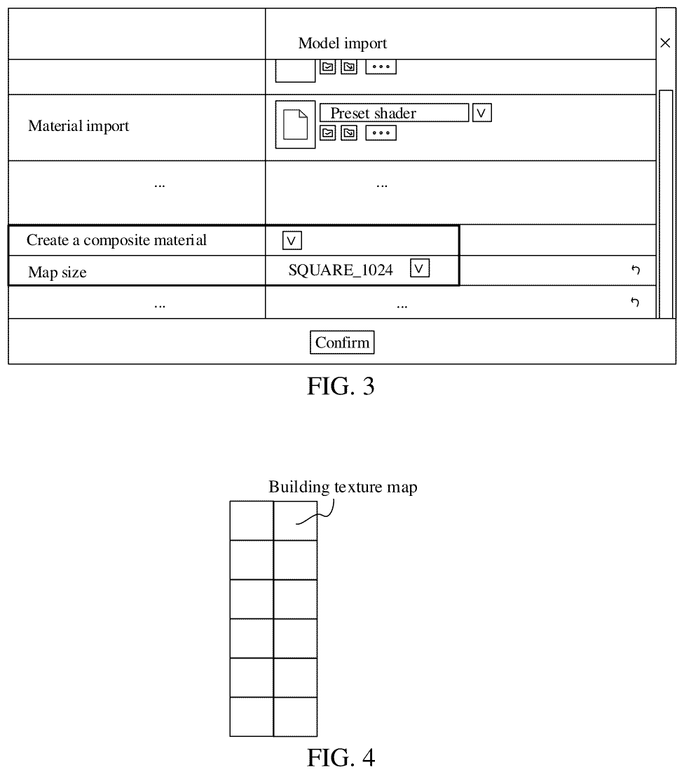

In a specific application, when the plurality of building texture maps are merged into the texture data through the building group import tool, and the rendering material parameter is generated based on the texture data, import configuration for model importing needs to be performed on the engine editor. A configuration interface may be shown in FIG. 3. During configuration, creating a composite material and a unified map size (SQUARE_1024 shown in FIG. 3) of a building texture map need to be selected, and a material (where a preset shader is selected as shown in FIG. 3) needs to be selected from existing basic materials for importing. Based on importing of the basic material, the rendering material parameter may be generated through the imported basic material and the generated texture data. The rendering material parameter may be generated after a “Confirm” control is clicked. The existing basic materials may be configured according to the actual application scenario. The unified map size of the building texture map is selected, so that map sizes of the plurality of building texture maps can be unified, and the map sizes of the plurality of building texture maps in the texture data are the same.

In a specific application, adding the indexes of corresponding building texture maps in the texture data to the vertexes of the plurality of building models refers to adding the indexes of corresponding building texture maps in the texture data to map texture coordinates corresponding to the vertexes in the corresponding building texture maps during importing. For example, before the texture data is generated, a form of the map texture coordinates may be [U1, V1], where U1 and V1 are corresponding texture coordinates of a vertex in a corresponding building texture map, and after the texture data is generated, the form of the map texture coordinates may be [U1, V1, index 1], where index 1 refers to an index of a building texture map corresponding to a vertex in the texture data. The building texture map corresponding to the vertex may be a building texture map configured for rendering the vertex.

The texture coordinates refer to UV coordinates, and are configured for indicating a location of a building texture map from which sampling is performed, that is, a pixel color is collected. U refers to a horizontal direction, and V refers to a vertical direction. The texture coordinates may be understood as percentage coordinates on the building texture map. A range of the texture coordinates may be from 0 to 1 or may exceed 1. In a case that the range of the texture coordinates exceeds 1, a part of the texture coordinates exceeding 1 represents reuse. For example, if coordinates of two adjacent vertexes are (0, 0) and (0, 1.5), it represents that the building texture map is reused in the V direction. A rendered basic geometric figure is a triangle, and the two adjacent vertexes refer to any two vertexes in any triangle.

Operation 204: Splice the plurality of building texture maps based on the map information in the texture data, to generate a physical texture map of the building group model.

A computer device splices the plurality of building texture maps based on the map information in the texture data when determining that the at least one to-be-rendered target building block model exists in the building group model, to generate the physical texture map of the building group model.

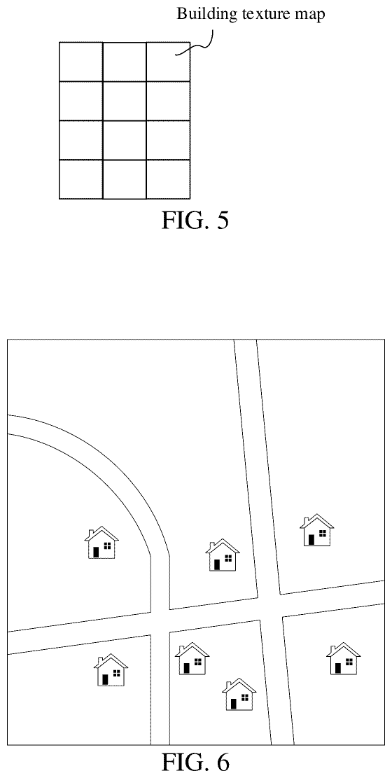

The physical texture map may be generated by splicing the plurality of building texture maps based on a pre-configured map splicing parameter. The physical texture map may be obtained by splicing real texture maps. The map splicing parameter may be configured according to the actual application scenario, and may specifically include a quantity of spliced images in a first direction and a quantity of spliced images in a second direction. The plurality of building texture maps are spliced based on different quantities of spliced images in the first direction and different quantities of spliced images in the second direction, so that different physical texture maps may be generated. For example, it is assumed that a quantity of the plurality of building texture maps is 12, the quantity of spliced images in the first direction (which is assumed to be in a horizontal direction) is 2, and the quantity of spliced images in the second direction (which is assumed to be in a longitudinal direction) is 6, a form of the generated physical texture map may be shown in FIG. 4. For another example, it is assumed that the quantity of the plurality of building texture maps is 12, the quantity of spliced images in the first direction (which is assumed to be in the horizontal direction) is 3, and the quantity of spliced images in the second direction (which is assumed to be in the longitudinal direction) is 4, the form of the generated physical texture map may be shown in FIG. 5.

The physical texture map includes a spliced image for each of at least one texture level. For each of the at least one texture level, the spliced image of the texture level is obtained by splicing texture images of the texture level of the plurality of building texture maps. The texture level may also be referred to as a mip level, that is, the physical texture map includes at least one spliced image of the mip level. In a case that the at least one mip level is a plurality of mip levels, in the physical texture map, as mip levels decrease, resolutions of spliced images of the plurality of mip levels decrease progressively with the mip levels. For example, it is assumed that the plurality of mip levels are a mip 0 level and a mip 1 level, a spliced image size of the mip 0 level may be 64*64 pixels, a spliced image size of the mip 1 level may be 32*32 pixels, and a resolution of the spliced image of the mip 0 level is greater than a resolution of the spliced image of the mip 1 level.

Specifically, the building group model includes the plurality of building block models obtained by splitting. The terminal determines, from the plurality of building block models based on a camera position of a pre-configured virtual camera, whether the at least one to-be-rendered target building block model exists; when determining that the at least one to-be-rendered target building block model exists, obtains and saves file handles of the plurality of building texture maps based on the map information of the plurality of building texture maps of the building group model in the texture data; and generates the physical texture map of the building group model by using the file handles of the plurality of building texture maps. In a specific application, after obtaining and saving the file handles of the plurality of building texture maps, the terminal may read the plurality of building texture maps by using the file handles of the plurality of building texture maps, and splice the plurality of read building texture maps, to generate the physical texture maps of the building group model.

Operation 206: Determine, for each target pixel point configured for performing texture sampling in the at least one target building block model, physical texture coordinates corresponding to the target pixel point in the physical texture map, and determine virtual texture coordinates corresponding to the target pixel point in a preset virtual texture map based on the physical texture coordinates.

The target pixel point refers to a pixel point configured for performing texture sampling when the target building block model is rendered. The physical texture coordinates refer to texture coordinates corresponding to the target pixel point in the physical texture map. The virtual texture map is a pre-stored data container that is configured for filling the virtual texture map with the physical texture map. The concept of the virtual texture map is similar to the concept of virtual memory, and is used during graphic rendering. Large complex textures may be divided into small blocks, and the blocks are loaded and rendered only when needed. The virtual texture map is used, so that memory use and rendering time can be reduced, and graphic quality and flexibility can be improved. The virtual texture coordinates refer to texture coordinates corresponding to the target pixel point in the virtual texture map.

Specifically, in a case that the physical texture map is generated, for each target pixel point in the at least one target building block, the terminal relocates map texture coordinates corresponding to the target pixel point in the corresponding building texture map, and maps the map texture coordinates to the physical texture map, to obtain the physical texture coordinates corresponding to the target pixel point in the physical texture map. In a case that the physical texture coordinates are determined, the terminal determines a target texture level corresponding to the target pixel point, and performs coordinate conversion on the physical texture coordinates based on the target texture level, to obtain the virtual texture coordinates corresponding to the target pixel point in the preset virtual texture map. The building texture map corresponding to the target pixel point refers to a texture map configured for rendering a target building block including the target pixel point. The building texture map corresponding to the target pixel point may be a building texture map configured for rendering the target pixel point.

In a specific application, the target texture level corresponding to the target pixel point refers to a texture level to which a part of a physical texture map that needs to be obtained and filled into the virtual texture map belongs before a texture pixel matching the virtual texture coordinates corresponding to the target pixel point is sampled, that is, a texture level to which a part of a physical texture map corresponding to the target pixel point belongs. When the physical texture map includes the spliced image for each of the at least one texture level, a part of the physical texture map that needs to be obtained and filled into the virtual texture map belongs to a spliced image of the target texture level. In other words, the terminal obtains, from the spliced image of the target texture level, the part of the physical texture map corresponding to the target pixel point for filling.

In a specific application, the target texture level corresponding to the target pixel point may also be understood as a target texture level corresponding to a target building block model to which the target pixel point belongs, and may be determined based on a distance between the target building block model to which the target pixel point belongs and the pre-configured virtual camera. Specifically, a closer distance between the target building block model to which the target pixel point belongs and the pre-configured virtual camera indicates a higher target texture level corresponding to the target pixel point, and a farther distance between the target building block model to which the target pixel point belongs and the pre-configured virtual camera indicates a lower target texture level corresponding to the target pixel point.

In a specific application, a mapping relationship between the distance between the target building block model and the pre-configured virtual camera and the texture level may be pre-configured. Different distances correspond to different texture levels. Based on determining the distance between the target building block model and the pre-configured virtual camera, the target texture level corresponding to the target pixel point may be determined based on the distance. The pre-configured mapping relationship may be configured according to the actual application scenario. For example, the pre-configured mapping relationship may be: in a form in which when a distance is within a range of X1 meters, a texture level is 0, and when a distance is greater than X1 meters and less than X2 meters, a texture level is 1.

Operation 208: Determine a virtual texture block in which the virtual texture coordinates are located in the virtual texture map, determine a part of the physical texture map corresponding to the virtual texture block in the physical texture map based on a mapping relationship between the virtual texture map and the physical texture map, fill the virtual texture map with a part of the physical texture map corresponding to the target pixel point, and sample, from the virtual texture map, a texture pixel matching the virtual texture coordinates corresponding to the target pixel point.

The virtual texture map is filled with the part of the physical texture map corresponding to the target pixel point, and the texture pixel matching the virtual texture coordinates corresponding to the target pixel point is sampled from the virtual texture map.

The texture pixel refers to a texture pixel value in the virtual texture map, for example, may be a texture color value. Sampling refers to a process of extracting an individual or a sample from a total. In this aspect, sampling a texture pixel may refer to reading a color value on virtual texture coordinates from the virtual texture map through the virtual texture coordinates. This process is texture sampling.

Specifically, in a case that the virtual texture coordinates are determined, the terminal may determine the virtual texture block in which the virtual texture coordinates are located in the virtual texture map, and then determine the part of the physical texture map corresponding to the virtual texture block in the physical texture map based on the mapping relationship between the virtual texture map and the physical texture map, fill the virtual texture map with the part of the physical texture map corresponding to the virtual texture block used as the part of the physical texture map corresponding to the target pixel point, and sample, from the virtual texture map, the texture pixel matching the virtual texture coordinates corresponding to the target pixel point.

Operation 210: Render the at least one target building block model by using the texture pixel matching the virtual texture coordinates corresponding to each target pixel point.

Specifically, the shader on the terminal may render the at least one target building block model by using the texture pixel matching the virtual texture coordinates corresponding to each target pixel point, to obtain a rendered image of at least a part of the building group. The shader is a small program running in a graphic processing unit in a graphics card, and is configured to process calculations on various graphic units in parallel. In a specific application, the obtained rendered image of at least the part of the building group may be shown in FIG. 6, and includes at least a part (including seven buildings as shown in FIG. 6) of the rendered building group. For ease of illustration, colors of the rendered image are not shown in FIG. 6.

According to the foregoing building group rendering method, the building group model shares one rendering material parameter. When texture sampling is performed, only the part of the physical texture map corresponding to the target pixel point is filled with the virtual texture map, and no additional video memory of the map is added, which can effectively reduce video memory usage. In an entire process, overload of a central processing unit is avoided by reducing a quantity of times of calling the drawing interface, and video memory usage of the physical texture map is optimized by using the virtual texture map to effectively reduce video memory usage, so that normal running of the computer device can be ensured during rendering.

According to the foregoing building group rendering method, the building group model is obtained, the building group model indicates the rendering material parameter configured for rendering the building group, and the rendering material parameter includes the texture data. Because the texture data includes the map information of the plurality of building texture maps of the building group model, the building group model can share one rendering material parameter, which facilitates merging processing, can reduce the quantity of times of calling the drawing interface, and avoids overload of the central processing unit. When it is determined that at least one to-be-rendered target building block model exists in the building group model, based on the map information in the texture data, the physical texture map of the building group model is generated. For each target pixel point in the at least one target building block model configured for performing texture sampling, the physical texture coordinates corresponding to the target pixel point are first determined, then the virtual texture coordinates corresponding to the target pixel point are determined based on the physical texture coordinates, then the part of the physical texture map corresponding to the target pixel point is filled with the virtual texture map based on the virtual texture coordinates, and the texture pixel matching the virtual texture coordinates corresponding to the target pixel point is sampled from the virtual texture map, so that video memory usage of the physical texture map can be optimized by using the virtual texture map. When texture sampling is performed, only the part of the physical texture map corresponding to the target pixel point is filled with the virtual texture map, and no additional video memory of the map is added, which can effectively reduce video memory usage, so that the at least one target building block model can be rendered by directly using the texture pixel matching the virtual texture coordinates corresponding to each target pixel point. In an entire process, overload of a central processing unit is avoided by reducing a quantity of times of calling the drawing interface, and video memory usage of the physical texture map is optimized by using the virtual texture map to effectively reduce video memory usage, so that normal running of the computer device can be ensured during rendering.

In an aspect, the building group model includes a plurality of building block models obtained by splitting; and the building group rendering method further includes: respectively determining distances between building block centers of a plurality of building block models and a pre-configured virtual camera; and selecting, from the plurality of building block models, at least one building block model whose distance to the pre-configured virtual camera is less than a preset distance as the at least one to-be-rendered target building block model.

The building block center refers to a center of a bounding box of the building block model. The bounding box refers to a geometric space capable of accommodating an object. In this aspect, the bounding box of the building block model refers to a geometric space capable of accommodating the building block model. The bounding box of the building block model in this aspect may refer to a smallest bounding box capable of accommodating the building block model. The virtual camera may also be referred to as a camera model, and is a virtual model configured for capturing a picture in a virtual scenario including the building group model. The virtual camera includes camera information similar to camera information of a physical camera, such as a camera position, a posture, an aperture size, and a focal length. The picture captured by the virtual camera in the virtual scenario may be determined through the camera information of the virtual camera in the virtual scenario.

Specifically, the building group model includes the plurality of building block models obtained by splitting. When determining the at least one to-be-rendered target building block model in the building group model, the terminal first respectively determines the distances between the building block centers of the plurality of building block models and the pre-configured virtual camera, and selects, from the plurality of building block models, the at least one building block model whose distance to the pre-configured virtual camera is less than the preset distance as the at least one to-be-rendered target building block model. The preset distance may be configured according to the actual application scenario.

In this aspect, on the basis of determining the distances between the building block centers of the plurality of building block models and the pre-configured virtual camera, the at least one to-be-rendered target building block model is determined from the plurality of building block models based on the distances, so that a building block model that does not need to be displayed can be deleted through the distances, thereby improving rendering efficiency.

In an aspect, the initial model of the building group includes a plurality of building models; and the plurality of building block models are obtained by splitting the plurality of building models based on bounding boxes respectively corresponding to the plurality of building models and a pre-configured building block size.

A bounding box of the building model refers to a geometric space capable of accommodating the building model. The bounding box of the building model in this aspect may be a smallest bounding box capable of accommodating the building model. The pre-configured building block size refers to a building block size configured in advance, which may be configured according to the actual application scenario.

Specifically, the initial model of the building group includes the plurality of building models, and the plurality of building block models included in the building group model are obtained by splitting the plurality of building models based on the bounding boxes respectively corresponding to the plurality of building models and the pre-configured building block size. In a specific application, a process of splitting the plurality of building models may be performed through the engine editor. The engine editor first determines the bounding boxes respectively corresponding to the plurality of building models, uses, for each of the plurality of building models, a center of the bounding box of the building model as a model center of the building model, splits the plurality of building models based on model centers of the plurality of building models and the pre-configured building block size, and splits the plurality of building models into the plurality of building block models.

In this aspect, the model center of the building model can be determined by using the bounding box of the building model, then the plurality of building models can be split based on the pre-configured building block size and the model centers of the plurality of building models, to obtain the plurality of building block models, so that rendering efficiency can be improved based on deletion performed on the plurality of building block models during rendering.

In an aspect, each target pixel point configured for performing texture sampling in the at least one target building block model is determined in the following manner:
determining, for each target building block model of the at least one target building block model based on the distance between the target building block model and the pre-configured virtual camera, a to-be-rendered level-of-detail model corresponding to the target building block model, and determining a target pixel point of the target building block model based on a vertex on the to-be-rendered level-of-detail model.

The target building block model includes a plurality of level-of-detail models of different levels. The level-of-detail model refers to a model constructed based on a levels of detail (LOD) technology. The levels of detail technology reduces geometric complexity of a scenario by simplifying surface details of an object in sequence without affecting a visual effect of a picture, thereby improving efficiency of a drawing algorithm. Each level-of-detail model retains details of a specific level, and during drawing, an appropriate level-of-detail model may be selected according to different standards to represent the target building block model.

Specifically, for each target building block model of the at least one target building block model, the target building block model includes the plurality of level-of-detail models of different levels. When determining the target pixel point of the target building block model, the terminal needs to determine, based on the distance between the target building block model and the pre-configured virtual camera, the to-be-rendered level-of-detail model corresponding to the target building block model, and perform rasterization processing based on the vertex on the to-be-rendered level-of-detail model, to determine the target pixel point of the target building block model. A quantity of vertexes on the level-of-detail models of different levels are different. A higher level indicates a larger quantity of vertexes on a level-of-detail model that can display more details.

In a specific application, if the distance between the target building block model and the pre-configured virtual camera is closer, more model details need to be displayed in the target building block model, and a level-of-detail model that can display more details needs to be selected. If the distance between the target building block model and the pre-configured virtual camera is farther, less model details need to be selected in the target building block model, and a level-of-detail model that can roughly represent the target building block model may be selected.

In a specific application, a mapping relationship between the distance between the target building block model and the pre-configured virtual camera and a level-of-detail model may be preset. Different distances correspond to level-of-detail models of different levels. On the basis of determining the distance between the target building block model and the pre-configured virtual camera, the to-be-rendered level-of-detail model corresponding to the target building block model may be determined based on the distance.

In a specific application, for each target building block model of the at least one target building block model, the plurality of level-of-detail models of different levels included in the target building block model may be pre-edited. Editing herein means that any building model of the target building block model may be added to another building model as a specific level-of-detail of the building model. In this manner, the plurality of level-of-detail models of different levels may be constructed. When any building model is added to another building model as a specific level-of-detail of the building model, whether vertex formats of the two building models are the same, that is, whether vertex attributes are the same needs to be considered. Only when the vertex formats of the two building models are the same, adding may be performed.

In this aspect, for buildings in the target building block model, the level-of-detail models of different levels are generated in a manner of reducing a building density, so that rendering performance can be optimized. Based on the generated level-of-detail models of different levels, the to-be-rendered level-of-detail model is determined based on the distance between the target building block model and the pre-configured virtual camera. Determining the target pixel point of the target building block model based on the vertex on the to-be-rendered level-of-detail model, rather than determining the target pixel point based on all vertexes on the target building block model, can efficiency reducing a quantity of vertexes that need to be processed during image rendering, and improving rendering efficiency.

In an aspect, the splicing the plurality of building texture maps based on the map information in the texture data, to generate a physical texture map of the building group model includes:
obtaining file handles of the plurality of building texture maps based on the map information of the plurality of building texture maps in the texture data;
loading, for each texture level of the at least one texture level based on the file handles of the plurality of building texture maps, texture images of the texture level of the plurality of building texture maps for splicing, to obtain a spliced image of the texture level; and
generating the physical texture map of the building group model based on the spliced image for each of the at least one texture level.

In a file system, to read data from a file, an application first needs to call an operating system function, transmit a file name, and select a path to the file to open the file. The function retrieves a sequence number, that is, a file handle, and the file handle is a unique identification basis for the opened file. To read a piece of data from the file, the application needs to call a function ReadFile, and transmits an address of the file handle in a memory and a number of bytes to be copied to an operating system. After a task is completed, the file is closed by calling the system function. In this aspect, that is, the texture image for each of the at least one texture level of the building texture map is read through the file handle of the building texture map.

Specifically, the terminal obtains, based on the map information of the plurality of building texture maps in the texture data, the file handles of the plurality of building texture maps, and saves the file handles of the plurality of building texture maps, each building texture map including the texture image for each of the at least one texture level. For each texture level of the at least one texture level, the terminal reads and loads, based on the file handles of the plurality of building texture maps, texture images of the texture level of the plurality of building texture maps; splices the obtained texture images of the texture level, to obtain the spliced image of the texture level; and generates the physical texture map of the building group model based on the spliced image for each of the at least one texture level, that is, the physical texture map of the building group model includes the spliced image for each of the at least one texture level.

In a specific application, the map information of the plurality of building texture maps in the texture data may be specifically reference paths of the plurality of building texture maps. The reference path refers to a path required for positioning and reference of the building texture maps during image rendering, and may be understood as a storage path of the building texture maps on the terminal. For each building texture map, the terminal may obtain the file handle of the building texture map based on the reference path of the building texture map, and then read, based on the file handle of the building texture map, the texture image for each of the at least one texture level of the building texture map.

In this aspect, the file handle can be obtained based on the map information. Further, the file handle may be used to obtain and load the texture images for each of at least one texture level of the plurality of building texture maps, so that the spliced image for each of the at least one texture level may be obtained by separately splicing the texture image for each of the at least one texture level. The physical texture map of the building group model is generated based on the spliced image for each of the at least one texture level.

In an aspect, the determining, for each target pixel point configured for performing texture sampling in the at least one target building block model, physical texture coordinates corresponding to the target pixel point in the physical texture map includes:
determining a map splicing parameter corresponding to the physical texture map, the map splicing parameter including a quantity of spliced images in a first direction and a quantity of spliced images in a second direction; and
determining, for each target pixel point configured for performing texture sampling in the at least one target building block model, the map texture coordinates corresponding to the target pixel point in the corresponding building texture map, and determining, based on the quantity of spliced images in the first direction, the quantity of spliced images in the second direction, and the map texture coordinates, the physical texture coordinates corresponding to the target pixel point in the physical texture map.

The map splicing parameter refers to a parameter that is set when texture images of each texture level of the plurality of building texture maps are spliced, may be pre-configured according to the actual application scenario, and may specifically include the quantity of spliced images in the first direction and the quantity of spliced images in the second direction. The plurality of building texture maps are spliced based on different quantities of spliced images in the first direction and different quantities of spliced images in the second direction, so that different physical texture maps may be generated.

Specifically, when determining the physical texture coordinates corresponding to the target pixel point in the physical texture map, the terminal first determines the map splicing parameter corresponding to the physical texture map, the map splicing parameter including the quantity of spliced images in the first direction and the quantity of spliced images in the second direction. On this basis, for each target pixel point among the at least one target building block, the terminal first determines the map texture coordinates corresponding to the target pixel point in the corresponding building texture map, then relocates the map texture coordinates based on the quantity of spliced images in the first direction and the quantity of spliced images in the second direction, and maps the map texture coordinates to the physical texture map, to obtain the physical texture coordinates corresponding to the target pixel point in the physical texture map.

In a specific application, the map texture coordinates corresponding to the target pixel point in the corresponding building texture map may be obtained through interpolation by using map texture coordinates corresponding to a plurality of target vertexes in the target building block model in the same building texture map. The target vertex refers to a vertex adjacent to the target pixel point in the target building block model.

In a specific application, a region in which the building texture map is located may be positioned from the physical texture map based on an index of the building texture map in the texture data in the map texture coordinates, the quantity of spliced images in the first direction, and the quantity of spliced images in the second direction, and then texture coordinates corresponding to the target pixel point in the corresponding building texture map in the map texture coordinates may be relocated based on a physical texture coordinate range of the region in which the building texture map is located, to obtain the physical texture coordinates corresponding to the target pixel point in the physical texture map.

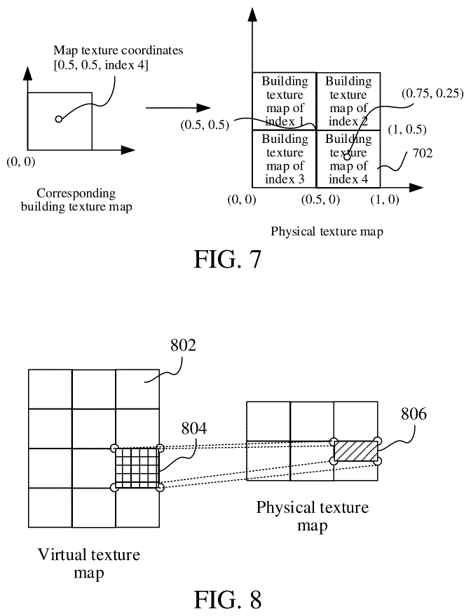

In a specific application, when the texture coordinates of the target pixel point in the map texture coordinates in the corresponding building texture map are relocated, to obtain the physical texture coordinates corresponding to the target pixel point, because reuse of building texture maps between two vertexes in the building model may exist, but each target pixel point is directly sampled, integer removal needs to be performed on the texture coordinates of the target pixel point in the corresponding building texture map, and then texture coordinates after integer removal is performed are relocated based on the physical texture coordinate range of the region in which the building texture map is located, to obtain the physical texture coordinates corresponding to the target pixel point in the physical texture map. The integer removal herein means removing an integer part of the texture coordinates of the target pixel point in the corresponding building texture map, and retaining only a decimal part. For example, if the texture coordinates of the target pixel point in the corresponding building texture map are (1.5, 1.5), texture coordinates obtained after integer removal is performed are (0.5, 0.5). In a specific application, as shown in FIG. 7, an example in which the map texture coordinates corresponding to the target pixel point in the corresponding building texture map is [0.5, 0.5, index 4](it is assumed that an origin of texture coordinates of the building texture map is at a lower left corner as shown in FIG. 7), and map splicing parameters corresponding to the physical texture map are as follows: the quantity of spliced images in the first direction (which is a horizontal direction as shown in FIG. 7) is 2, and the quantity of spliced images in the second direction (which is a longitudinal direction as shown in FIG. 7) is 2 is used. The region in which the building texture map is located may be positioned from the physical texture map based on an index of the building texture map in texture data in the map texture coordinates, the quantity of spliced images in the first direction, and the quantity of spliced images in the second direction is a region 702. Then, physical texture coordinates (0.75, 0.25) corresponding to the target pixel point in the physical texture map may be obtained based on a physical texture coordinate range of the region in which the building texture map is located (it is assumed that an origin of texture coordinates of the physical texture map is also at a lower left corner, four physical texture coordinates of the physical texture coordinate range are: an upper left corner (0.5, 0.5), an upper right corner (1, 0.5), a lower left corner (0.5, 0), and a lower right corner (1, 0)).

In this aspect, the map splicing parameter corresponding to the physical texture map is determined, so that the quantity of spliced images in the first direction and the quantity of spliced images in the second direction that are included in the map splicing parameter can be used to relocate the map texture coordinates corresponding to the target pixel point in the corresponding building texture map, and to determine the physical texture coordinates corresponding to the target pixel point in the physical texture map.

In an aspect, the determining virtual texture coordinates corresponding to the target pixel point in a preset virtual texture map based on the physical texture coordinates includes:
determining the target texture level corresponding to the target pixel point;
calculating a first size ratio between a spliced image size corresponding to the target texture level and a map size of the preset virtual texture map; and
performing coordinate conversion on the physical texture coordinates based on the first size ratio, to obtain the virtual texture coordinates corresponding to the target pixel point in the preset virtual texture map.

Specifically, spliced images of different texture levels have different spliced image sizes. A higher texture level indicates a larger spliced image size, and a lower texture level indicates a smaller spliced image size. For example, a spliced image size of a spliced image of a mip 0 level is greater than a spliced image size of a spliced image of a mip 1 level, and the spliced image size of the spliced image of the mip 1 level is greater than a spliced image size of a spliced image of a mip 2 level. Therefore, to implement accurate coordinate conversion, the terminal needs to first determine the target texture level corresponding to the target pixel point, then calculate the first size ratio between the spliced image size corresponding to the target texture level and a map size of a pre-created virtual texture map, and then perform coordinate conversion on the physical texture coordinates based on the first size ratio, to obtain the virtual texture coordinates corresponding to the target pixel point in the preset virtual texture map.

In a specific application, it is assumed that the spliced image size corresponding to the target texture level is m, and the map size of the pre-created virtual texture map is n, it may be obtained that the first size ratio is m/n. If the physical texture coordinates are (U2, V2), it may be obtained that the virtual texture coordinates corresponding to the target pixel point in the preset virtual texture map are (U2*(m/n), V2*(m/n)).

In this aspect, the target texture level corresponding to the target pixel point is determined, and the first size ratio between the spliced image size corresponding to the target texture level and the map size of the pre-created virtual texture map is calculated, so that the first size ratio can be used to implement conversion of the physical texture coordinates, to obtain the virtual texture coordinates corresponding to the target pixel point in the preset virtual texture map.

In an aspect, the determining a part of the physical texture map corresponding to the virtual texture block in the physical texture map based on a mapping relationship between the virtual texture map and the physical texture map includes:
determining, based on first position information of the virtual texture block in the virtual texture map, second position information of a physical texture block corresponding to the virtual texture block in the physical texture map based on the mapping relationship between the virtual texture map and the physical texture map; and
obtaining, from the physical texture map based on the second position information, the part of the physical texture map corresponding to the target pixel point.

The first position information refers to a texture coordinate range of the virtual texture block in the virtual texture map, and the second position information refers to a texture coordinate range of the physical texture block in the physical texture map.

Specifically, when the virtual texture map is filled with the part of the physical texture map corresponding to the target pixel point, the terminal needs to first determine the virtual texture block in which the virtual texture coordinates are located in the virtual texture map, then perform position mapping based on the first position information of the virtual texture block in the virtual texture map, determine the second position information of the physical texture block corresponding to the virtual texture block in the physical texture map, and finally obtain, from the physical texture map based on the second position information, the part of the physical texture map corresponding to the target pixel point, and fill the virtual texture block of the virtual texture map with the part of the physical texture map corresponding to the target pixel point.

In a specific application, because the second position information refers to the texture coordinate range of the physical texture block in the physical texture map, when obtaining the part of the physical texture map corresponding to the target pixel point from the physical texture map based on the second position information, the terminal obtains a texture map in the second position information in the physical texture map, and uses the texture map in the second position information as the part of the physical texture map corresponding to the target pixel point.

In a specific application, the virtual texture map may be configured for filling the physical texture map, the virtual texture map includes a plurality of virtual texture blocks, and each of the virtual texture blocks may be configured for filling at least a part of the physical texture map. In a case that at least a part of the virtual texture blocks are configured for filling the physical texture map, each of the virtual texture blocks configured for filling corresponds to one physical texture block in the physical texture map, and one physical texture block indicates one texture coordinate range. Based on this, the texture pixel matching the virtual texture coordinates corresponding to the target pixel point may be sampled from the virtual texture block filled with the physical texture map in the virtual texture map.

In a specific application, as shown in FIG. 8, the virtual texture map includes a plurality of virtual texture blocks 802. It is assumed that a virtual texture block in which the virtual texture coordinates are located in the virtual texture map is a virtual texture block 804, position mapping is performed based on first position information (including texture coordinates of four vertexes of the virtual texture block, and the four vertexes are represented by four small circles in FIG. 8) of the virtual texture block 804 in the virtual texture map, second position information (which are texture coordinates of four vertexes of the physical texture block shown in FIG. 8, and the four vertexes are represented by four small circles in FIG. 8) of a physical texture block corresponding to the virtual texture block in the physical texture map may be determined, and then based on the second position information, the part of the physical texture map (which is a part of the physical texture map in a physical texture block 806 shown in FIG. 8) corresponding to the target pixel point is obtained from the physical texture map for filling.

In this aspect, the virtual texture block in which the virtual texture coordinates are located in the virtual texture map is first determined, so that the first position information of the virtual texture block in the virtual texture map can be used to determine the second position information of the physical texture block corresponding to the virtual texture block in the physical texture map. Then, based on the second position information, the part of the physical texture map corresponding to the target pixel point can be obtained from the physical texture map for filling, which can implement accurate filling. Therefore, accurate texture sampling can be performed based on the filled map, thereby implementing accurate rendering.

In an aspect, the determining, based on first position information of the virtual texture block in the virtual texture map, second position information of a physical texture block corresponding to the virtual texture block in the physical texture map includes:
determining the target texture level corresponding to the target pixel point;
calculating a second size ratio between a map size of the virtual texture map and a spliced image size corresponding to the target texture level; and
performing coordinate conversion on the first position information of the virtual texture block in the virtual texture map based on the second size ratio, to obtain the second position information of the physical texture block corresponding to the virtual texture block in the physical texture map.

Specifically, spliced images of different texture levels have different spliced image sizes. A higher texture level indicates a larger spliced image size, and a lower texture level indicates a smaller spliced image size. Therefore, to implement accurate coordinate conversion, the terminal needs to first determine the target texture level corresponding to the target pixel point, then calculate the second size ratio between the map size of the virtual texture map and the spliced image size corresponding to the target texture level, and then perform coordinate conversion on the first position information of the virtual texture block in the virtual texture map based on the second size ratio, to obtain the second position information of the physical texture block corresponding to the virtual texture block in the physical texture map.

In a specific application, it is assumed that the spliced image size corresponding to the target texture level is m, and the map size of the virtual texture map is n, it may be obtained that the second size ratio is n/m. If the first position information (including texture coordinates of four vertexes of the virtual texture block, which are respectively texture coordinates 1, texture coordinates 2, texture coordinates 3, and texture coordinates 4), the second position information (including texture coordinates of four vertexes of the physical texture block, which are respectively texture coordinates 1*(n/m), texture coordinates 2*(n/m), texture coordinates 3*(n/m), and texture coordinates 4*(n/m)) of the physical texture block corresponding to the virtual texture block in the physical texture map may be obtained. In a coordinate conversion process, it is assumed that an origin of texture coordinates of the physical texture map corresponds to an origin of texture coordinates of the virtual texture map. For example, the origins of texture coordinates may be vertexes at a lower left corner of the physical texture map and the virtual texture map.

In this aspect, the target texture level corresponding to the target pixel point is determined, and the second size ratio is calculated based on the target texture level, so that the second size ratio can be used to implement conversion of the first position information, to obtain the second position information. Then, based on the second position information, the part of the physical texture map corresponding to the target pixel point can be obtained from the physical texture map for filling, which can implement accurate filling. Therefore, accurate texture sampling can be performed based on the filled map, thereby implementing accurate rendering.

In an aspect, the physical texture map includes the spliced image for each of at least one texture level; and the obtaining, from the physical texture map based on the second position information, the part of the physical texture map corresponding to the target pixel point includes:
obtaining, from the spliced image of the target texture level based on the second position information, the part of the physical texture map corresponding to the target pixel point when the physical texture map includes the spliced image of the target texture level, the target texture level referring to a texture level to which the part of the physical texture map corresponding to the target pixel point belongs.

Specifically, after determining the second position information, the terminal needs to determine whether the physical texture map includes the spliced image of the target texture level. In a case that the physical texture map includes the spliced image of the target texture level, the terminal directly obtains, from the spliced image of the target texture level based on the second position information, the texture map in the second position information as the part of the physical texture map corresponding to the target pixel point. The target texture level refers to the texture level to which the part of physical texture map corresponding to the target pixel point belongs. When the physical texture map includes the spliced image for each of the at least one texture level, the part of the physical texture map that needs to be obtained and filled into the virtual texture map belongs to the spliced image of the target texture level. Therefore, whether the physical texture map includes the spliced image of the target texture level needs to be first determined.

In a specific application, it is assumed that the physical texture map includes the spliced image of the mip 0 level and the spliced image of the mip 1 level, and the texture level to which the part of the physical texture map corresponding to the target pixel point belongs is the mip 1 level, the part of the physical texture map corresponding to the target pixel point, that is, the texture map in the second position information in the spliced image of the mip 1 level, may be directly obtained from the spliced image of the mip 1 level based on the second position information.

In this aspect, in a case that the spliced image of the target texture level exists, the part of the physical texture map corresponding to the target pixel point can be obtained from the spliced image of the target texture level based on the second position information.

In an aspect, the physical texture map includes the spliced image for each of at least one texture level; and the obtaining, from the physical texture map based on the second position information, the part of the physical texture map corresponding to the target pixel point includes:
loading texture images of the target texture level of the plurality of building texture maps when the physical texture map does not include the spliced image of the target texture level;
splicing the texture images of the target texture level of the plurality of building texture maps, to obtain the spliced image of the target texture level; and
obtaining, from the spliced image of the target texture level based on the second position information, the part of the physical texture map corresponding to the target pixel point.

Specifically, in a case that the physical texture map does not include the spliced image of the target texture level, the terminal needs to first read and load, based on the saved file handles of the plurality of building texture maps, the texture images of the target texture level of the plurality of building texture maps, then splice the texture images of the target texture level of the plurality of building texture maps, to obtain the spliced image of the target texture level, and obtain, from the spliced image of the target texture level based on the second position information, the texture map in the second position information as the part of the physical texture map corresponding to the target pixel point.

In a specific application, it is assumed that the physical texture map includes the spliced image of the mip 0 level and the spliced image of the mip 1 level, and the texture level to which the part of the physical texture map corresponding to the target pixel point belongs is a mip 2 level, the terminal needs to first read and load, based on the saved file handles of the plurality of building texture maps, texture images of the mip 2 level of the plurality of building texture maps, splice the texture images of the mip 2 level of the plurality of building texture maps, to obtain a spliced image of the mip 2 level, and then obtain, from the spliced image of the mip 2 level based on the second position information, the part of the physical texture map corresponding to the target pixel point, that is, the texture map in the second position information of the spliced image of the mip 2 level.

In this aspect, in a case that the physical texture map does not include the spliced image of the target texture level, the texture image is first loaded, then the texture image is spliced to obtain the spliced image of the target texture level, and then the part of the physical texture map corresponding to the target pixel point is obtained from the spliced image of the target texture level based on the second position information, so that the part of the physical texture map corresponding to the target pixel point can be obtained.

In an aspect, the building group rendering method described herein mainly includes a loading process and a rendering process.

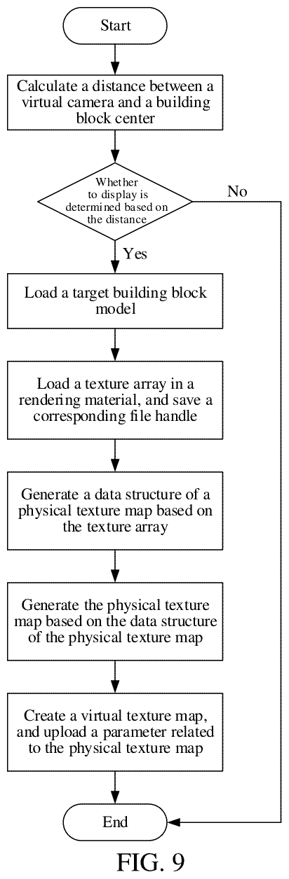

A schematic flowchart of the loading process may be shown in FIG. 9. The terminal obtains a building group model, the building group model indicating a rendering material parameter configured for rendering a building group, and the rendering material parameter including texture data; respectively determines distances between building block centers of a plurality of building block models and a pre-configured virtual camera; and determines, based on the distances, whether to display the building block model, that is, whether at least one to-be-rendered target building block model exists. If the at least one to-be-rendered target building block model exists, the terminal loads at least one target building block model (mesh material), loads the texture data in the rendering material parameter, obtains and saves file handles of the plurality of building texture maps based on map information of the plurality of building texture maps in the texture data, generates a data structure of a physical texture map based on the texture data, the data structure of the physical texture map including a spliced image for each of the at least one texture level, generates a physical texture map of the building group model based on the spliced image for each of the at least one texture level, creates a virtual texture map, and uploads a parameter related to the physical texture map, that is, a map splicing parameter.

In a specific application, a manner of generating the spliced image for each of the at least one texture level based on the texture data may be: loading, for each texture level of the at least one texture level based on the file handles of the plurality of building texture maps, texture images of the texture level of the plurality of building texture maps, and splicing the texture images of the texture level, to obtain a spliced image of the texture level.

In a specific application, the building group model includes the plurality of building block models obtained by splitting, and the plurality of building block models may be obtained by splitting a plurality of building models included in an initial model of the building group.

In a specific application, the initial model of the building group and the plurality of building texture maps are drawn by a drawing object by using computer graphics software (such as Houdini). After the drawing is completed, an engine editor may obtain the initial model of the building group including the plurality of building models and the plurality of building texture maps that are outputted from the computer graphics software, and convert the initial model of the building group including the plurality of building models and the plurality of building texture maps into a format that can be used by the rendering engine, to generate the rendering material parameter. The terminal obtains the rendering material parameter generated by the engine editor. The format that can be used by the rendering engine herein may be configured according to the actual application scenario. In a specific application, the engine editor may convert, through a pre-configured building group import tool, the initial model of the building group including the plurality of building models and the plurality of building texture maps into the format that can be used by the rendering engine, to generate the rendering material parameter. During importing, the engine editor first merges the plurality of building texture maps into the texture data, adds indexes of corresponding building texture maps in the texture data to vertexes of the plurality of building models, and then generates the rendering material parameter based on the texture data, to facilitate use by the rendering engine. The initial model of the building group including the plurality of building models is obtained by merging the plurality of building models. The merging herein is mainly to merge models that use the same shader but use different building texture maps as materials. When the plurality of building models are merged to obtain the initial model of the building group, the plurality of building texture maps are merged into the texture data.

In a specific application, a process of splitting the plurality of building models may be executed by using a model editing tool of the engine editor. The model editing tool of the engine editor first determines bounding boxes respectively corresponding to the plurality of building models, uses, for each of the plurality of building models, a center of the bounding box of the building model as a model center of the building model, splits the plurality of building models based on model centers of the plurality of building models and the pre-configured building block size, and splits the plurality of building models into the plurality of building block models.

In a specific application, after the plurality of building block models are obtained by splitting, for each building block model of the plurality of building block models, the model editing tool in the engine editor may pre-edit the plurality of level-of-detail models of different levels included in the building block model. Editing herein means that any building block model of the building block models may be added to another building model as a specific level-of-detail of the building model. In this manner, the plurality of level-of-detail models of different levels may be constructed. When any building model is added to another building model as the specific level-of-detail of the building model, whether vertex formats of the two building models are the same, that is, whether vertex attributes are the same needs to be considered. Only when the vertex formats of the two building models are the same, adding may be performed.

Resources (including the building group models, the rendering material parameters, and the like) involved described herein may all be automatically generated by using a tool (such as the model editing tool and the building group import tool in the foregoing aspects), and the saved models, rendering material parameters, and building texture maps may all be matched. In addition, an entire process may be autonomously controlled based on a parameter configuration of a tool, such as a building block size, configuration of a level-of-detail model, and a type of used texture data.

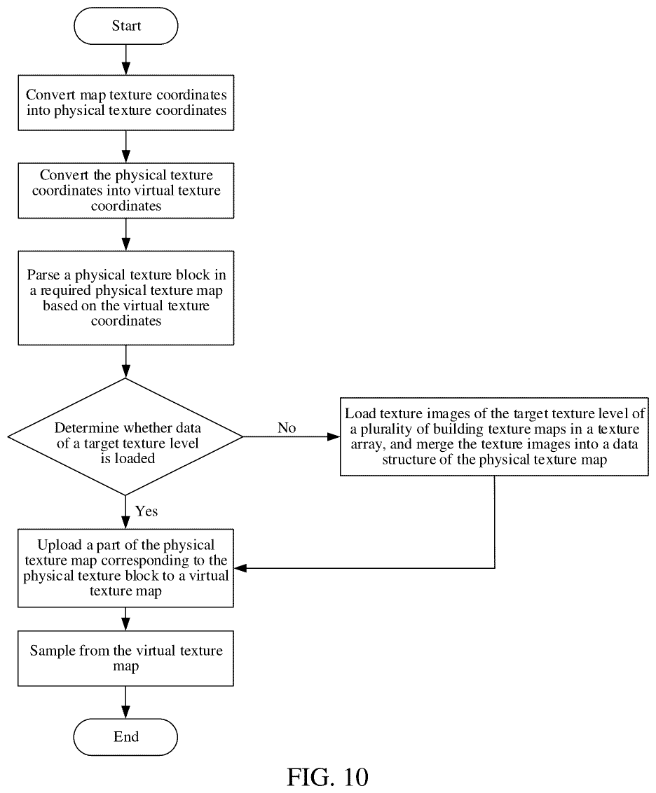

A schematic flowchart of the rendering process may be shown in FIG. 10. During rendering, for each target pixel point configured for performing texture sampling in the at least one target building block model, the map texture coordinates of the target pixel point in the corresponding physical texture map are converted into the physical texture coordinates of the physical texture map, that is, the physical texture coordinates corresponding to the target pixel point in the physical texture map are determined, the virtual texture coordinates corresponding to the target pixel point in the pre-created virtual texture map are determined based on the physical texture coordinates, a physical texture block in a required physical texture map is parsed based on the virtual texture coordinates, and whether data of the target texture level corresponding to the target pixel point is loaded, that is, whether the physical texture map includes the spliced image of the target texture level. When the physical texture map includes the spliced image of the target texture level, the part of the physical texture map corresponding to the physical texture block (that is, the part of the physical texture map corresponding to the target pixel point) is obtained from the spliced image of the target texture level based on the second position information of the physical texture block, and uploaded to the virtual texture map (that is, filled into the virtual texture map), the texture pixel matching the virtual texture coordinates corresponding to the target pixel point is sampled from the virtual texture map, and the at least one target building block model is rendered by using the texture pixel matching the virtual texture coordinates corresponding to each target pixel point, to obtain a rendered image of at least a part of the building group.

When the physical texture map does not include the spliced image of the target texture level, the texture images of the target texture level of the plurality of building texture maps in the texture data are loaded, the texture images of the target texture level of the plurality of building texture maps are spliced, to obtain the spliced image of the target texture level, the spliced image of the target texture level is merged into the data structure of the physical texture map, and the part of the physical texture map corresponding to the target pixel point is obtained from the spliced image of the target texture level based on the second position information.

In an aspect, during rendering, each target pixel point configured for performing texture sampling in the at least one target building block model further needs to be determined, and each target pixel point configured for performing texture sampling in the at least one target building block model may be determined in the following manner: determining, for each target building block model of the at least one target building block model based on a distance between the target building block model and the pre-configured virtual camera, a to-be-rendered level-of-detail model corresponding to the target building block model, and determining a target pixel point of the target building block model based on a vertex on the to-be-rendered level-of-detail model.

In an aspect, a manner of determining the physical texture coordinates corresponding to the target pixel point in the physical texture map may be: determining a map splicing parameter corresponding to the physical texture map, the map splicing parameter including a quantity of spliced images in a first direction and a quantity of spliced images in a second direction; determining, for each target pixel point configured for performing texture sampling in the at least one target building block model, map texture coordinates corresponding to the target pixel point in a corresponding building texture map; and determining, based on the quantity of spliced images in the first direction, the quantity of spliced images in the second direction, and the map texture coordinates, the physical texture coordinates corresponding to the target pixel point in the physical texture map.

In an aspect, a manner of determining virtual texture coordinates corresponding to the target pixel point in a preset virtual texture map based on the physical texture coordinates may be: determining the target texture level corresponding to the target pixel point; calculating a first size ratio between a spliced image size corresponding to the target texture level and a map size of the preset virtual texture map; and performing coordinate conversion on the physical texture coordinates based on the first size ratio, to obtain the virtual texture coordinates corresponding to the target pixel point in the preset virtual texture map.

In an aspect, a manner of parsing a physical texture block in a required physical texture map based on the virtual texture coordinates may be: determining a virtual texture block in which the virtual texture coordinates are located in the virtual texture map; and determining, based on first position information of the virtual texture block in the virtual texture map, second position information of a physical texture block corresponding to the virtual texture block in the physical texture map. A texture map in the second position information, that is, a part of the physical texture map corresponding to the target pixel point, may be obtained from the physical texture map based on the second position information.

In an aspect, a manner for determining second position information of a physical texture block corresponding to the virtual texture block in the physical texture map may be: determining the target texture level corresponding to the target pixel point; calculating a second size ratio between a map size of the virtual texture map and a spliced image size corresponding to the target texture level; and performing coordinate conversion on the first position information of the virtual texture block in the virtual texture map based on the second size ratio, to obtain the second position information of the physical texture block corresponding to the virtual texture block in the physical texture map.

According to the building group rendering method provided described herein, different building texture maps are merged into one piece of texture data, so that the building group model can share one rendering material parameter, which facilitates merging processing, can reduce a quantity of times of calling the drawing interface, and avoids overload of the central processing unit. In addition, based on the virtual texture map, a flow of the texture data is supported, and video memory usage of the physical texture map is optimized by using the virtual texture map. When texture sampling is performed, only the part of the physical texture map corresponding to the target pixel point is filled with the virtual texture map, and no additional video memory of the map is added, which can effectively reduce video memory usage. In addition, described herein, the building group model is partitioned, and mesh merging is performed on building models in a building block model that is separately partitioned, so that the deletion function of the rendering engine is fully used on the premise of controlling the draw call, thereby improving performance. For building models in the same sub-building block, different level-of-detail models are generated in a manner of reducing building density, so that rendering efficiency can be improved.

In an aspect, in a case that the building group model and the texture data included in the rendering material parameter indicated by the building group model are obtained, and the at least one to-be-rendered target building block model in the building group model is determined, the at least one target building block model may be rendered in the following manner: The terminal may first perform deserialization on the texture data, sequentially load the plurality of building texture maps into a memory, copy and merge textures of the graphic processing unit of the loaded plurality of building texture maps to form texture data of an image processing unit, sample, for each target pixel point configured for performing texture sampling in the at least one target building block model, a corresponding building texture map in the shader based on an index of texture data in a vertex attribute of the target pixel point, to obtain a texture pixel matching the map texture coordinates corresponding to the target pixel point, and render the at least one target building block model by using the texture pixel matching the map texture coordinates corresponding to each target pixel point, to obtain a rendered image of at least a part of the building group.

According to the building group rendering method described herein, the draw call for building group rendering can be extremely reduced. After the plurality of building texture maps are merged by using the texture data, a building model of one building block model can be controlled in one draw call by using automatic merging of the rendering engine. Secondly, the texture data is optimized by using the virtual texture map. In a scenario in which there is an existing virtual texture map, provided that a format of saved map is the same, it can be ensured that no additional video memory of the maps is added, a loading flow and a building block flow for the map are provided, and a pressure on the central processing unit is reduced.

In an aspect, the building group rendering method described herein may be applied to urban building image rendering. The inventor considers that during conventional large-scale urban building rendering, to enrich the effect, there are a large quantity of different types of buildings, and for the same type of building, there may be a plurality of styles of materials. Because merging policies in the conventional method are based on the same material, resulting in difficulty in merging buildings, and a quantity of draw calls cannot be reduced. In addition, a larger quantity of types means a larger quantity of maps, and a large amount of video memory is occupied. In addition, because a model of an urban building is very simple, basically, one building has dozens of faces, it is difficult to create a levels of detail model by effectively reducing the faces. Therefore, if a conventional method is continuously used to perform urban building image rendering, normal running of the computer device configured for rendering is affected. Based on this, this application provides a building group rendering method. When the building group rendering method described herein is applied to urban building image rendering, performance optimization can be implemented without affecting an effect thereof. In addition to being applied to urban building image rendering, the building group rendering method described herein may further be applied to rendering of a model cluster of any materials of a plurality styles, for example, may be applied to rendering of a virtual object model cluster of materials of a plurality of styles, and for another example, may be applied to rendering of a terrain model of materials of a plurality of styles. In actual application, for an urban region with 200,000 buildings, a conventional solution is used. Using an example in which image rendering is performed on a computer device configured with a 2060-8 GB video card and a 32 GB memory, a draw call of a distant view is approximately 4000 times, a frame per second (FPS) is approximately 30 times, a draw call of a close view is between 700 and 1000 times, and the FPS is approximately 40 times. However, after the building group rendering method described herein is applied, the draw call of the distant view may be controlled to approximately 100 times, the draw call of the close view are only one to two times, and the FPS is stable to approximately 60, and performance benefits are obvious.

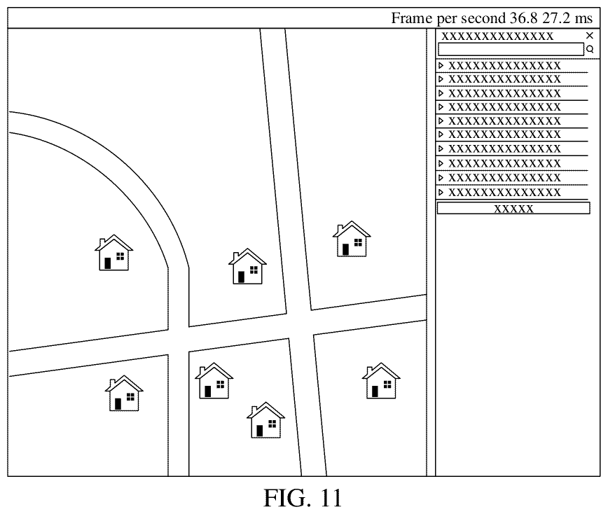

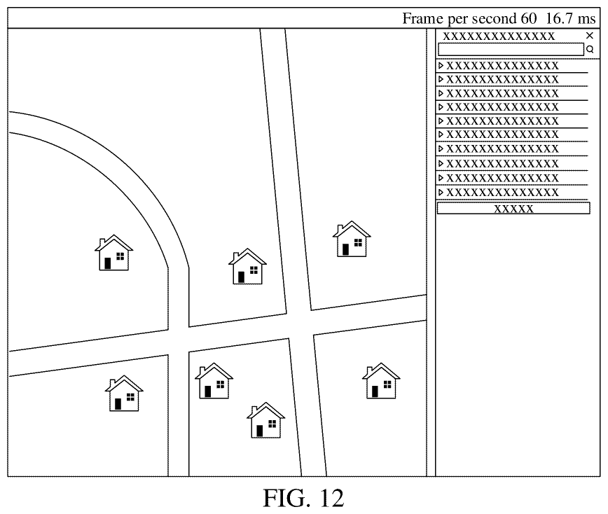

In an aspect, as shown in FIG. 11, FIG. 11 is a diagram of an effect of performing urban building image rendering by using a conventional solution. It can be learned from FIG. 11 that, the FPS is 36.8, and time consumption is 27.2 ms. As shown in FIG. 12, FIG. 12 is an effect diagram of rendering the same region in FIG. 11 by using a building group rendering method according to this application. It can be learned from FIG. 12 that, the FPS is 60, time consumption is 16.7 ms, and performance benefits are obvious.

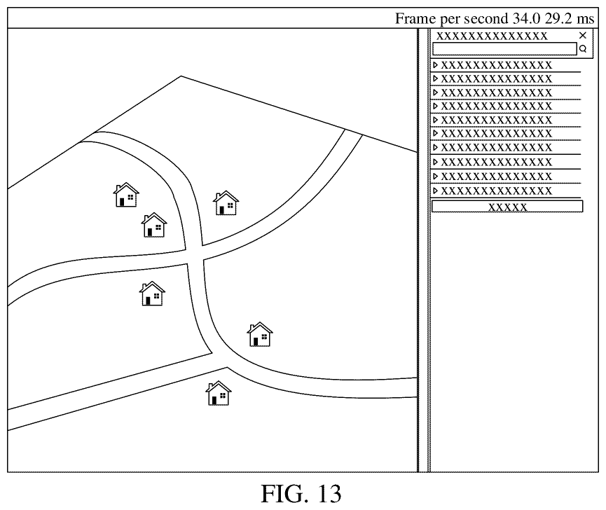

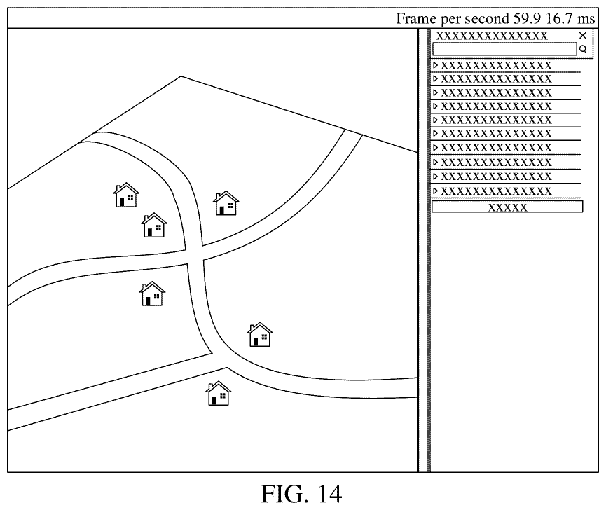

In an aspect, as shown in FIG. 13, FIG. 13 is another effect diagram of performing urban building image rendering by using a conventional solution. It can be learned from FIG. 13 that, the FPS is 34.0, and time consumption is 29.2 ms. As shown in FIG. 14, FIG. 14 is an effect diagram of rendering the same region in FIG. 13 by using a building group rendering method according to this application. It can be learned from FIG. 14 that, the FPS is 59.9, time consumption is 16.7 ms, and performance benefits are obvious.

Operations in flowcharts involved in the foregoing aspects are displayed in sequence based on indication of arrows, but the operations are not necessarily performed in sequence based on a sequence indicated by the arrows. Unless otherwise explicitly specified in this specification, the operations are performed without any strict sequence limit, and may be performed in other sequences. In addition, at least some operations in the flowcharts involved in the foregoing aspects may include a plurality of operations or a plurality of stages, and these operations or stages are not necessarily performed at the same moment, but may be performed at different moments. These operations or stages are not necessarily performed in sequence, but may be performed by turn or alternately with other operations or at least some operations or stages in other operations.

Based on the same concept, an aspect described herein further provides a building group rendering apparatus for implementing the foregoing building group rendering method. The implementation solution for resolving the problem provided by this apparatus is similar to the implementation solution recorded in the foregoing method. Therefore, for the specific limitations in one or more aspects of the building group rendering apparatus provided below, reference may be made to the foregoing limitations for the building group rendering method, and the description is not repeated herein again.

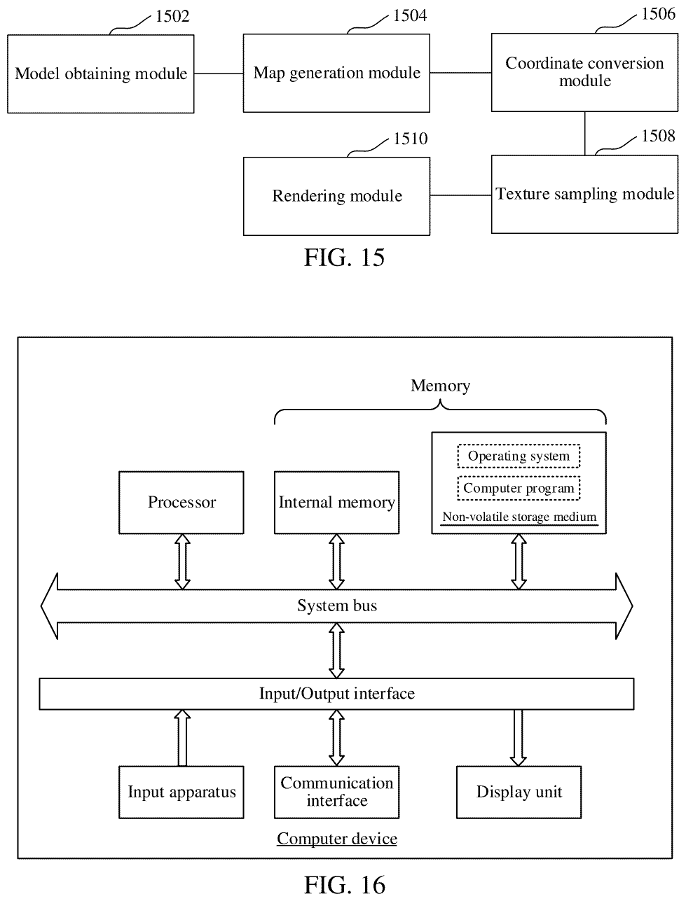

In an aspect, as shown in FIG. 15, a building group rendering apparatus is provided, including: a model obtaining module 1502, a map generation module 1504, a coordinate conversion module 1506, a texture sampling module 1508, and a rendering module 1510,
the model obtaining module 1502 being configured to obtain a building group model, the building group model indicating a rendering material parameter configured for rendering a building group, the rendering material parameter including texture data, the texture data including map information of a plurality of building texture maps of the building group model, and the building group model including at least one to-be-rendered target building block model;
the map generation module 1504 being configured to splice the plurality of building texture maps based on the map information in the texture data, to generate a physical texture map of the building group model;
the coordinate conversion module 1506 being configured to: determine, for each target pixel point configured for performing texture sampling in the at least one target building block model, physical texture coordinates corresponding to the target pixel point in the physical texture map, and determine virtual texture coordinates corresponding to the target pixel point in a preset virtual texture map based on the physical texture coordinates;
the texture sampling module 1508 being configured to determine a virtual texture block in which the virtual texture coordinates are located in the virtual texture map, determine a part of the physical texture map corresponding to the virtual texture block in the physical texture map based on a mapping relationship between the virtual texture map and the physical texture map, fill the virtual texture map with a part of the physical texture map corresponding to the target pixel point, and sample, from the virtual texture map, a texture pixel matching the virtual texture coordinates corresponding to the target pixel point; and
the rendering module 1510 being configured to render the at least one target building block model by using the texture pixel matching the virtual texture coordinates corresponding to each target pixel point.

According to the foregoing building group rendering apparatus, the building group model is obtained, the building group model indicates the rendering material parameter configured for rendering the building group, and the rendering material parameter includes the texture data. Because the texture data includes the map information of the plurality of building texture maps of the building group model, the building group model can share one rendering material parameter, which facilitates merging processing, can reduce the quantity of times of calling the drawing interface, and avoids overload of the central processing unit. When it is determined that at least one to-be-rendered target building block model exists in the building group model, based on the map information in the texture data, the physical texture map of the building group model is generated. For each target pixel point in the at least one target building block model configured for performing texture sampling, the physical texture coordinates corresponding to the target pixel point are first determined, then the virtual texture coordinates corresponding to the target pixel point are determined based on the physical texture coordinates, then the part of the physical texture map corresponding to the target pixel point is filled with the virtual texture map based on the virtual texture coordinates, and the texture pixel matching the virtual texture coordinates corresponding to the target pixel point is sampled from the virtual texture map, so that video memory usage of the physical texture map can be optimized by using the virtual texture map. When texture sampling is performed, only the part of the physical texture map corresponding to the target pixel point is filled with the virtual texture map, and no additional video memory of the map is added, which can effectively reduce video memory usage, so that the at least one target building block model can be rendered by directly using the texture pixel matching the virtual texture coordinates corresponding to each target pixel point. In an entire process, overload of a central processing unit is avoided by reducing a quantity of times of calling the drawing interface, and video memory usage of the physical texture map is optimized by using the virtual texture map to effectively reduce video memory usage, so that normal running of the computer device can be ensured during rendering.

In an aspect, the building group model includes a plurality of building block models obtained by splitting; and the map generation module is further configured to respectively determine distances between building block centers of a plurality of building block models and a pre-configured virtual camera, and determine, based on the distances, the at least one to-be-rendered target building block model from the plurality of building block models.

In an aspect, an initial model of the building group includes a plurality of building models; and the plurality of building block models are obtained by splitting the plurality of building models based on bounding boxes respectively corresponding to the plurality of building models and a pre-configured building block size.

In an aspect, the coordinate conversion module is further configured to: determine, for each target building block model of the at least one target building block model, based on a distance between the target building block model and the pre-configured virtual camera, a to-be-rendered level-of-detail model corresponding to the target building block model, and determine a target pixel point of the target building block model based on a vertex on the to-be-rendered level-of-detail model.

In an aspect, the map generation module is further configured to obtain file handles of the plurality of building texture maps based on the map information of the plurality of building texture maps in the texture data; load, for each texture level of the at least one texture level based on the file handles of the plurality of building texture maps, texture images of the texture level of the plurality of building texture maps; splice the texture images of the texture level, to obtain a spliced image of the texture level; and generate the physical texture map of the building group model based on the spliced image for each of the at least one texture level.

In an aspect, the coordinate conversion module is further configured to determine a map splicing parameter corresponding to the physical texture map, the map splicing parameter including a quantity of spliced images in a first direction and a quantity of spliced images in a second direction; determine, for each target pixel point configured for performing texture sampling in the at least one target building block model, map texture coordinates corresponding to the target pixel point in a corresponding building texture map; and determine, based on the quantity of spliced images in the first direction, the quantity of spliced images in the second direction, and the map texture coordinates, the physical texture coordinates corresponding to the target pixel point in the physical texture map.

In an aspect, the coordinate conversion module is further configured to determine a target texture level corresponding to the target pixel point; calculate a first size ratio between a spliced image size corresponding to the target texture level and a map size of the preset virtual texture map; and perform coordinate conversion on the physical texture coordinates based on the first size ratio, to obtain the virtual texture coordinates corresponding to the target pixel point in the preset virtual texture map.

In an aspect, the texture sampling module is further configured to determine a virtual texture block in which the virtual texture coordinates are located in the virtual texture map; determine, based on first position information of the virtual texture block in the virtual texture map, second position information of a physical texture block corresponding to the virtual texture block in the physical texture map; obtain, from the physical texture map based on the second position information, the part of the physical texture map corresponding to the target pixel point, and fill the virtual texture map with the part of the physical texture map corresponding to the target pixel point.

In an aspect, the texture sampling module is further configured to determine the target texture level corresponding to the target pixel point; calculate a second size ratio between a map size of the virtual texture map and a spliced image size corresponding to the target texture level; and perform coordinate conversion on the first position information of the virtual texture block in the virtual texture map based on the second size ratio, to obtain the second position information of the physical texture block corresponding to the virtual texture block in the physical texture map.

In an aspect, the physical texture map includes a spliced image for each of at least one texture level; and the texture sampling module is further configured to: obtain, from the spliced image of the target texture level based on the second position information, the part of the physical texture map corresponding to the target pixel point when the physical texture map includes the spliced image of the target texture level, the target texture level referring to a texture level to which the part of the physical texture map corresponding to the target pixel point belongs.

In an aspect, the physical texture map includes a spliced image for each of at least one texture level; and the texture sampling module is further configured to: load the texture images of the target texture level of the plurality of building texture maps when the physical texture map does not include the spliced image of the target texture level; splice the texture images of the target texture level of the plurality of building texture maps, to obtain the spliced image of the target texture level; and obtain, from the spliced image of the target texture level based on the second position information, the part of the physical texture map corresponding to the target pixel point.

The modules in the foregoing building group rendering apparatus may be implemented entirely or partially by software, hardware, or a combination thereof. The foregoing modules may be built in or independent of a processor of a computer device in a hardware form, or may be stored in a memory of a computer device in a software form, so that the processor calls and performs an operation corresponding to each of the foregoing modules.

In an aspect, a computer device is provided. The computer device may be a terminal or a server. For example, the computer device is the terminal, and an internal structure diagram thereof may be shown in FIG. 16. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and a computer program stored therein. The internal memory provides an environment for running of the operating system and the computer program in the non-volatile storage medium. The input/output interface of the computer device is configured to exchange information between the processor and an external device. The communication interface of the computer device is configured to communicate with an external terminal in a wired or a wireless manner, and the wireless manner can be implemented by using WIFI, a mobile cellular network, a near field communication (NFC), or other technologies. The computer program is executed by the processor to implement a building group rendering method. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad arranged on a housing of the computer device, or may be an external keyboard, a touch pad, a mouse, or the like.

A person skilled in the art may understand that, the structure shown in FIG. 16 is only a block diagram of a part of a structure related to a solution described herein and does not limit the computer device to which the solution described herein is applied. Specifically, the computer device may include more or fewer components than those in the drawings, or some components are combined, or a different component arrangement is used.

In an aspect, a computer device is further provided, including a memory and a processor, the memory having a computer program stored therein, and the processor, when executing the computer program, implementing the operations in the foregoing method aspects.

In an aspect, a computer-readable storage medium is provided, storing a computer program, and the computer program, when executed by a processor, implements the operations in the foregoing method aspects.

In an aspect, a computer program product is provided, storing a computer program, and the computer program, when executed by a processor, implements the operations in the foregoing method aspects.

A person of ordinary skill in the art may understand that all or some of procedures of the method in the foregoing implementations may be implemented by a computer program instructing relevant hardware. The computer program may be stored in a non-volatile computer-readable storage medium. When the computer program is executed, the procedures of the foregoing method implementations may be implemented. Any reference to a memory, a database, or another medium used in the aspects provided described herein may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of description instead of limitation, the RAM may be in a plurality of forms, such as a static random access memory (SRAM) or a dynamic random access memory (DRAM). The database involved in the aspects provided described herein may include at least one of a relational database and a non-relational database. The non-relational database may include a blockchain-based distributed database, but is not limited thereto. The processor involved in the aspects provided described herein may be a general-purpose processor, a central processing unit, a graphics processing unit, a digital signal processor, a programmable logic device, a quantum computing-based data processing logic device, and are not limited thereto.

The technical features in the foregoing aspects may be randomly combined. For concise description, not all possible combinations of the technical features in the aspect are described. However, provided that combinations of the technical features do not conflict with each other, the combinations of the technical features are considered as falling within the scope recorded in this specification.

The foregoing aspects only describe several implementations described herein specifically and in detail, but cannot be construed as a limitation to the patent scope described herein. A person of ordinary skill in the art may make various changes and improvements without departing from the ideas described herein, which shall all fall within the protection scope described herein. Therefore, the protection scope of this patent application is subject to the protection scope of the appended claims.

What is claimed is:

1. A computer-implemented method, comprising:
obtaining a building group model, the building group model indicating a rendering material parameter configured for rendering a building group, the rendering material parameter comprising texture data, the texture data comprising map information of a plurality of building texture maps of the building group model, and the building group model comprising at least one to-be-rendered target building block model;
splicing the plurality of building texture maps based on the map information in the texture data, to generate a physical texture map of the building group model;
determining, for each target pixel point configured for performing texture sampling in the at least one target building block model, physical texture coordinates corresponding to the target pixel point in the physical texture map, and determining virtual texture coordinates corresponding to the target pixel point in a preset virtual texture map based on the physical texture coordinates;
determining a virtual texture block in which the virtual texture coordinates are located in the virtual texture map, and determining a part of the physical texture map corresponding to the virtual texture block in the physical texture map based on a mapping relationship between the virtual texture map and the physical texture map;
filling the virtual texture map with a part of the physical texture map corresponding to the target pixel point, and sampling, from the virtual texture map, a texture pixel matching the virtual texture coordinates corresponding to the target pixel point; and
rendering the at least one target building block model using the texture pixel matching the virtual texture coordinates corresponding to each target pixel point.

2. The method according to claim 1, wherein the building group model comprises a plurality of building block models obtained by splitting, and the method further comprises:
determining a distance between each building block center of the plurality of building block models and a pre-configured virtual camera; and
selecting, from the plurality of building block models, at least one building block model whose distance to the pre-configured virtual camera is less than a preset distance as the at least one to-be-rendered target building block model.

3. The method according to claim 2, wherein an initial model of the building group comprises a plurality of building models, and the plurality of building block models are obtained by splitting the plurality of building models based on bounding boxes respectively corresponding to the plurality of building models and a pre-configured building block size.

4. The method of claim 1, wherein each target pixel point configured for performing texture sampling in the at least one target building block model is determined by:
determining, for each target building block model of the at least one target building block model, based on a distance between the target building block model and the pre-configured virtual camera, a to-be-rendered level-of-detail model corresponding to the target building block model, and determining a target pixel point of the target building block model based on a vertex on the to-be-rendered level-of-detail model.

5. The method of claim 1, wherein the splicing comprises:
obtaining file handles of the plurality of building texture maps based on the map information of the plurality of building texture maps in the texture data;
loading, for each texture level of at least one texture level based on the file handles of the plurality of building texture maps, texture images of the texture level of the plurality of building texture maps for splicing, to obtain a spliced image of the texture level; and
generating the physical texture map of the building group model based on the spliced image for each of the at least one texture level.

6. The method of claim 1, wherein the determining, for each target pixel point configured for performing texture sampling in the at least one target building block model, physical texture coordinates corresponding to the target pixel point in the physical texture map, comprises:
determining a map splicing parameter corresponding to the physical texture map, the map splicing parameter comprising a quantity of spliced images in a first direction and a quantity of spliced images in a second direction; and
determining, for each target pixel point configured for performing texture sampling in the at least one target building block model, map texture coordinates corresponding to the target pixel point in a corresponding building texture map, and determining, based on the quantity of spliced images in the first direction, the quantity of spliced images in the second direction, and the map texture coordinates, the physical texture coordinates corresponding to the target pixel point in the physical texture map.

7. The method of claim 1, wherein the determining virtual texture coordinates corresponding to the target pixel point in a preset virtual texture map based on the physical texture coordinates comprises:
determining a target texture level corresponding to the target pixel point;
calculating a first size ratio between a spliced image size corresponding to the target texture level and a map size of the preset virtual texture map; and
performing coordinate conversion on the physical texture coordinates based on the first size ratio, to obtain the virtual texture coordinates corresponding to the target pixel point in the virtual texture map.

8. The method of claim 1, wherein the determining the part of the physical texture map corresponding to the virtual texture block in the physical texture map based on the mapping relationship between the virtual texture map and the physical texture map, comprises:
determining, based on first position information of the virtual texture block in the virtual texture map, second position information of a physical texture block corresponding to the virtual texture block in the physical texture map based on the mapping relationship between the virtual texture map and the physical texture map; and
obtaining, from the physical texture map based on the second position information, the part of the physical texture map corresponding to the target pixel point.

9. The method of claim 8, wherein the determining second position information comprises:
determining a target texture level corresponding to the target pixel point;
calculating a second size ratio between a map size of the virtual texture map and the spliced image size corresponding to the target texture level; and
performing coordinate conversion on the first position information of the virtual texture block in the virtual texture map based on the second size ratio, to obtain the second position information of the physical texture block corresponding to the virtual texture block in the physical texture map.

10. The method of claim 8, wherein the physical texture map comprises the spliced image for each of the at least one texture level, and the obtaining, from the physical texture map based on the second position information, the part of the physical texture map corresponding to the target pixel point comprises:
obtaining, from the spliced image of the target texture level based on the second position information, the part of the physical texture map corresponding to the target pixel point when the physical texture map comprises a spliced image of the target texture level, the target texture level referring to a texture level to which the part of the physical texture map corresponding to the target pixel point belongs.

11. The method of claim 8, wherein the physical texture map comprises the spliced image for each of the at least one texture level, and the obtaining, from the physical texture map based on the second position information, the part of the physical texture map corresponding to the target pixel point comprises:
loading texture images of the target texture level of the plurality of building texture maps when the physical texture map does not comprise the spliced image of the target texture level;
splicing the texture images of the target texture level of the plurality of building texture maps, to obtain the spliced image of the target texture level; and
obtaining, from the spliced image of the target texture level based on the second position information, the part of the physical texture map corresponding to the target pixel point.

12. One or more non-transitory computer readable media comprising computer readable instructions that, when executed by a processor, configure a data processing system to perform:
obtaining a building group model, the building group model indicating a rendering material parameter configured for rendering a building group, the rendering material parameter comprising texture data, the texture data comprising map information of a plurality of building texture maps of the building group model, and the building group model comprising at least one to-be-rendered target building block model;
splicing the plurality of building texture maps based on the map information in the texture data, to generate a physical texture map of the building group model;
determining, for each target pixel point configured for performing texture sampling in the at least one target building block model, physical texture coordinates corresponding to the target pixel point in the physical texture map, and determining virtual texture coordinates corresponding to the target pixel point in a preset virtual texture map based on the physical texture coordinates;
determining a virtual texture block in which the virtual texture coordinates are located in the virtual texture map, and determining a part of the physical texture map corresponding to the virtual texture block in the physical texture map based on a mapping relationship between the virtual texture map and the physical texture map;
filling the virtual texture map with a part of the physical texture map corresponding to the target pixel point, and sampling, from the virtual texture map, a texture pixel matching the virtual texture coordinates corresponding to the target pixel point; and
rendering the at least one target building block model using the texture pixel matching the virtual texture coordinates corresponding to each target pixel point.

13. The method according to claim 12, wherein the building group model comprises a plurality of building block models obtained by splitting, and the method further comprises:
determining a distance between each building block center of the plurality of building block models and a pre-configured virtual camera; and
selecting, from the plurality of building block models, at least one building block model whose distance to the pre-configured virtual camera is less than a preset distance as the at least one to-be-rendered target building block model.

14. The method of claim 12, wherein each target pixel point configured for performing texture sampling in the at least one target building block model is determined by:
determining, for each target building block model of the at least one target building block model, based on a distance between the target building block model and the pre-configured virtual camera, a to-be-rendered level-of-detail model corresponding to the target building block model, and determining a target pixel point of the target building block model based on a vertex on the to-be-rendered level-of-detail model.

15. The method of claim 12, wherein the splicing comprises:
obtaining file handles of the plurality of building texture maps based on the map information of the plurality of building texture maps in the texture data;
loading, for each texture level of at least one texture level based on the file handles of the plurality of building texture maps, texture images of the texture level of the plurality of building texture maps for splicing, to obtain a spliced image of the texture level; and
generating the physical texture map of the building group model based on the spliced image for each of the at least one texture level.

16. The method of claim 12, wherein the determining, for each target pixel point configured for performing texture sampling in the at least one target building block model, physical texture coordinates corresponding to the target pixel point in the physical texture map, comprises:
determining a map splicing parameter corresponding to the physical texture map, the map splicing parameter comprising a quantity of spliced images in a first direction and a quantity of spliced images in a second direction; and
determining, for each target pixel point configured for performing texture sampling in the at least one target building block model, map texture coordinates corresponding to the target pixel point in a corresponding building texture map, and determining, based on the quantity of spliced images in the first direction, the quantity of spliced images in the second direction, and the map texture coordinates, the physical texture coordinates corresponding to the target pixel point in the physical texture map.

17. The method of claim 12, wherein the determining virtual texture coordinates corresponding to the target pixel point in a preset virtual texture map based on the physical texture coordinates comprises:
determining a target texture level corresponding to the target pixel point;
calculating a first size ratio between a spliced image size corresponding to the target texture level and a map size of the preset virtual texture map; and
performing coordinate conversion on the physical texture coordinates based on the first size ratio, to obtain the virtual texture coordinates corresponding to the target pixel point in the virtual texture map.

18. The method of claim 12, wherein the determining the part of the physical texture map corresponding to the virtual texture block in the physical texture map based on the mapping relationship between the virtual texture map and the physical texture map, comprises:
determining, based on first position information of the virtual texture block in the virtual texture map, second position information of a physical texture block corresponding to the virtual texture block in the physical texture map based on the mapping relationship between the virtual texture map and the physical texture map; and
obtaining, from the physical texture map based on the second position information, the part of the physical texture map corresponding to the target pixel point.

19. A system comprising: a processor, and memory storing computer readable instructions that, when executed by the processor, configure the system to perform:
obtaining a building group model, the building group model indicating a rendering material parameter configured for rendering a building group, the rendering material parameter comprising texture data, the texture data comprising map information of a plurality of building texture maps of the building group model, and the building group model comprising at least one to-be-rendered target building block model;
splicing the plurality of building texture maps based on the map information in the texture data, to generate a physical texture map of the building group model;
determining, for each target pixel point configured for performing texture sampling in the at least one target building block model, physical texture coordinates corresponding to the target pixel point in the physical texture map, and determining virtual texture coordinates corresponding to the target pixel point in a preset virtual texture map based on the physical texture coordinates;
determining a virtual texture block in which the virtual texture coordinates are located in the virtual texture map, and determining a part of the physical texture map corresponding to the virtual texture block in the physical texture map based on a mapping relationship between the virtual texture map and the physical texture map;
filling the virtual texture map with a part of the physical texture map corresponding to the target pixel point, and sampling, from the virtual texture map, a texture pixel matching the virtual texture coordinates corresponding to the target pixel point; and
rendering the at least one target building block model using the texture pixel matching the virtual texture coordinates corresponding to each target pixel point.

20. The system of claim 19, wherein the building group model comprises a plurality of building block models obtained by splitting, and the instructions, when executed, further configure the system to perform:
determining a distance between each building block center of the plurality of building block models and a pre-configured virtual camera; and
selecting, from the plurality of building block models, at least one building block model whose distance to the pre-configured virtual camera is less than a preset distance as the at least one to-be-rendered target building block model.
